(19) United States
(12) Patent Application Publication
(10) Pub. No.: US 2008/0216671 A1
(43) Pub. Date: Sep. 11, 2008

(54) Barbecue Stove

(76) Inventor: Jan-Nan Chen, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/733,881

(22) Filed: Apr. 11, 2007

(30) Foreign Application Priority Data
Mar. 3, 2007 (TW) 96107411

(51) Int. Cl. A47J 27/00

(52) U.S. Cl. 99/445

(57) ABSTRACT

A barbecue stove includes a body, a cover, a storage device, two primary feet and two secondary feet. The cover is pivotally connected to the body. The storage device is attached to the body. The primary feet are attached to the body. The secondary feet are attached to the storage device. The barbecue lies on the primary feet in use and stands on the secondary feet in storage.

### BACKGROUND OF INVENTION

1. Field of Invention

The present invention relates to a barbecue stove.

2. Related Prior Art

An electric barbecue stove has been disclosed in Taiwanese Patent M294907. The electric barbecue stove includes a body 1, a heater 14, thermal insulation material 15 and a container 2. The body 1 includes an internal layer 10 and an external layer 11. The heater 14 includes at least one heating loop wound around the internal layer 10. The thermal insulation material 15 is provided between the internal layer 10 and external layer 11. Disposed in the internal layer 10 of the body 1 is the container 2 for containing food. There are problems in the use of the electric barbecue stove. Firstly, it occupies a large area on the ground, a floor or table. Secondly, two hands are required to carry it. Thirdly, it cannot be used in places where there is not electricity.

The present invention is therefore intended to obviate or at least alleviate the problems encountered in prior art.

### SUMMARY OF INVENTION

According to the present invention, a barbecue stove includes a body, a cover, a storage device, two primary feet and two secondary feet. The cover is pivotally connected to the body. The storage device is attached to the body. The primary feet are attached to the body. The secondary feet are attached to the storage device. The barbecue lies on the primary feet in use and stands on the secondary feet in storage.

An advantage of the barbecue stove according to the present invention is that it requires a small space in storage.

Another advantage of the barbecue stove according to the present invention is that the storage device can be used to store a fuel can and other things such as an illuminating device.

Other advantages, objectives and features of the present invention will become apparent from the following description referring to the attached drawings.

### BRIEF DESCRIPTION OF DRAWINGS

The present invention will be described via detailed illustration of the preferred embodiment referring to the drawings.

FIG. 1 is a perspective view of a barbecue stove according to the preferred embodiment of the present invention.

FIG. 2 is an exploded view of the barbecue stove shown in FIG. 1.

FIG. 3 is another perspective view of the barbecue stove of FIG. 1.

FIG. 4 is a perspective view of the barbecue stove in another position than shown in FIG. 3.

FIG. 5 is a cross-sectional view of the barbecue stove taken along a line 5-5 shown in FIG. 4.

FIG. 6 is an enlarged partial view of the barbecue stove of FIG. 5.

FIG. 7 is a cross-sectional view of the barbecue stove taken along a line 7-7 shown in FIG. 4.

FIG. 8 is an enlarged partial view of the barbecue stove of FIG. 7.

FIG. 9 is a cross-sectional view of the barbecue stove taken along a line 9-9 shown in FIG. 4.

FIG. 10 is an enlarged partial view of the barbecue stove of FIG. 9.

### DETAILED DESCRIPTION OF PREFERRED EMBODIMENT

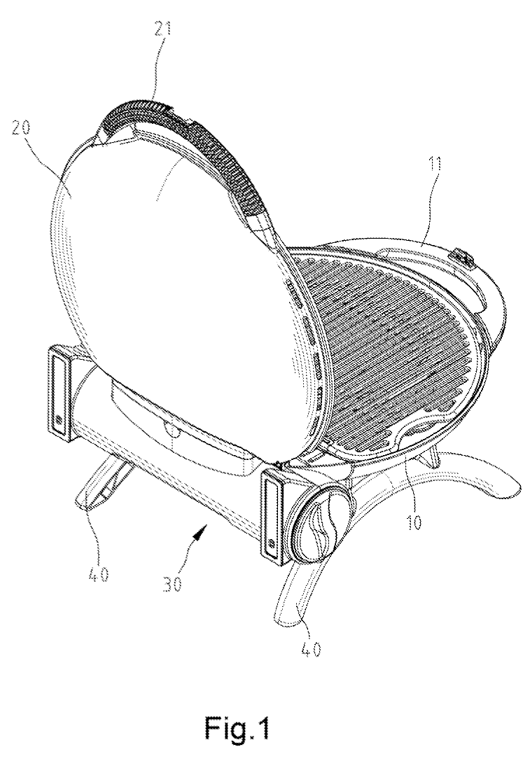

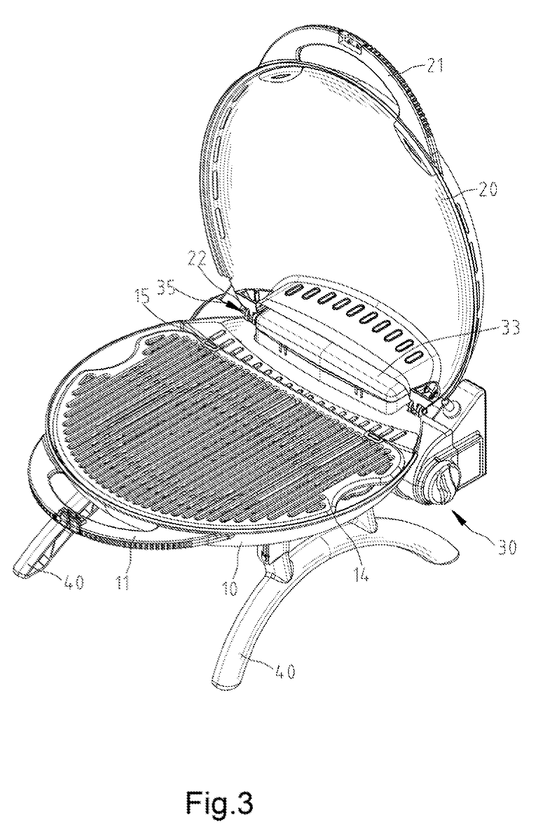

Referring to FIGS. 1 through 3, a barbecue stove includes a body 10, a heater 12, a grid 14, a cover 20, two primary feet 40, a storage device 30 and two secondary feet 324 according to the preferred embodiment of the present invention. The heater 12 is disposed in the body 10. The grid 14 is disposed in the body 10, above the heater 12. The cover 20 is pivotally connected to the body 10. The primary feet 40 are secured to the body 10. The storage device 30 is provided on the body 10. The secondary feet 324 are formed on the storage device 30.

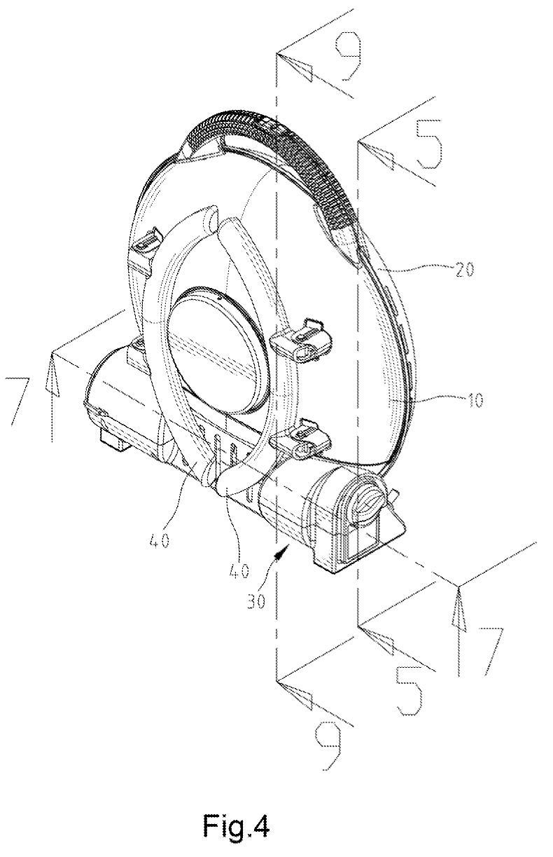

In use, the primary feet 40 are laid on the ground, a floor or table so that the body 10 is laid flat. The cover 20 is pivoted from the body 10. In storage, the cover 20 is pivoted to the body 10 and the secondary feet 324 are laid on the ground, floor or table so that the body 10 is disposed upright referring to FIG. 4. Therefore, the barbecue stove occupies a small area on the ground, floor or table.

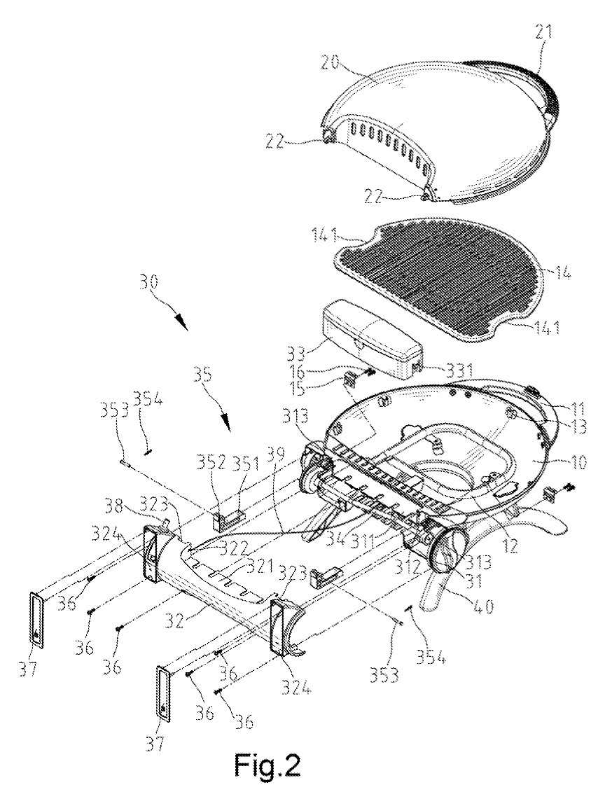

Referring to FIG. 2, the body 10 is shaped like a bowl. The body 10 includes a handle 11 attached to an external side thereof and brackets 13 attached to an internal side thereof. The handle 11 includes a skid-proof surface.

The grid 14 is supported on the brackets 13. The grid 14 may however be directly supported on the internal side of the body 10 in another embodiment wherein the brackets 13 is be omitted. Two recesses 141 are defined in the edge of the grid 14 so that when the grid 14 is disposed in the body 10, there are two spaces between the grid 14 and the body 10 to facilitate the handling of the grid 14.

The cover 20 includes a handle 21 provided on an external side thereof corresponding to the handle 11 and two ears 22 provided on the external side thereof. The handle 21 includes a skid-proof surface. The handle 21 can be joined to the handle 11.

The storage device 30 includes a cylinder attached to the body 10 and a box 33 detachably attached to the cylinder. The cylinder includes a first shell 31 attached to the body 10 and a second shell 32 attached to the first shell 31.

The first shell 31 includes a space 311 defined therein and two cutouts 313 defined therein. The space 311 is located between the cutouts 313. A slot 312 is defined in each of two walls between which the space 311 is defined.

The second shell 32 includes a space 321 defined therein and two cutouts 323 defined therein. The space 321 is located between the cutouts 323. A slot 322 is defined in each of two walls between which the space 321 is defined.

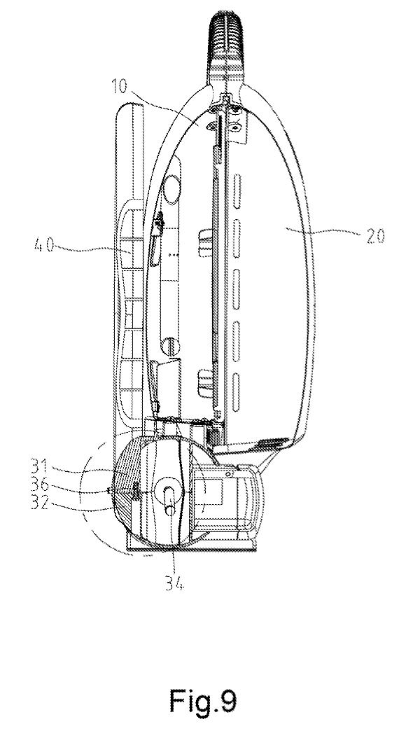

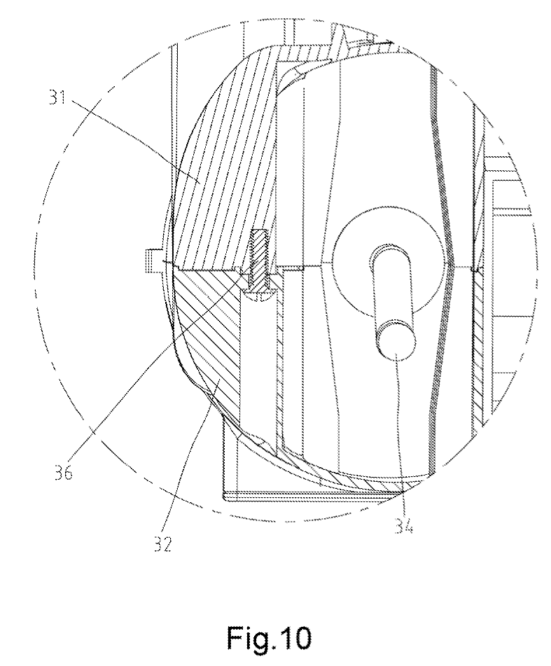

Referring to FIGS. 9 and 10, the second shell 32 is joined to the first shell 31 with threaded bolts 36. The secondary feet 324 are hollow for receiving the threaded bolts 36. A pad 37 is attached to each of the secondary feet 324, thus concealing the threaded bolts 36. Moreover, the pads 37 help the secondary feet 324 stand firmly on the ground, floor or table.

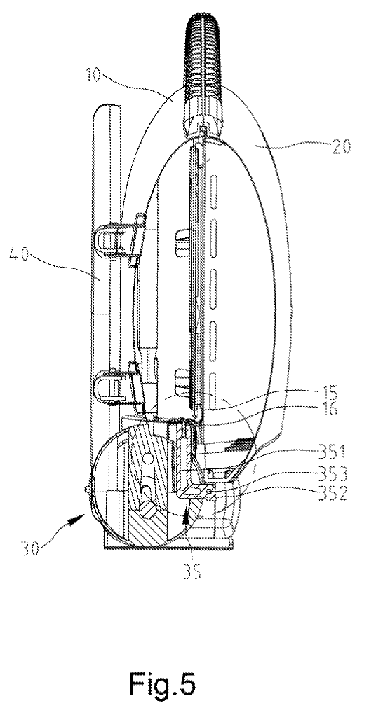

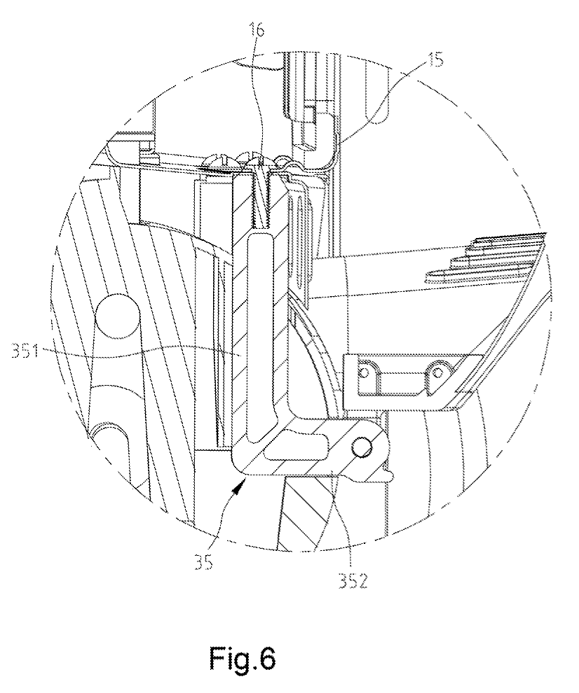

Referring to FIGS. 5 and 6, the cover 20 is pivotally connected to the body 10 with two hinges 35. Each of the hinges 35 is an L-shaped element including a first portion 351 and a second portion 352. The first portion 351 of each of the hinges 35 is attached to the body 10 with a threaded bolt 16.

Used together with each of the threaded bolt 16 is a tab 15. Each of the tabs 15 is an L-shaped element including a first portion and a second portion. Like a washer, the first portion of each of the tabs 15 is provided between the body 10 and an enlarged head of a related one of the threaded bolts 16. The second portion of each of the tabs 15 is used to restrain the grid 14. The first portions 351 of the hinges 35 are long so that the ears 22 are far from the heater 12. Therefore, the cover 20 is far from the heater 12 in operation. The cover 20 is not burning hot, and people will not be burnt by the cover 20.

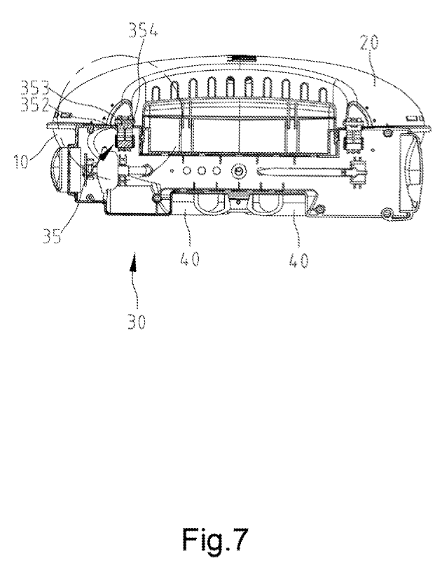

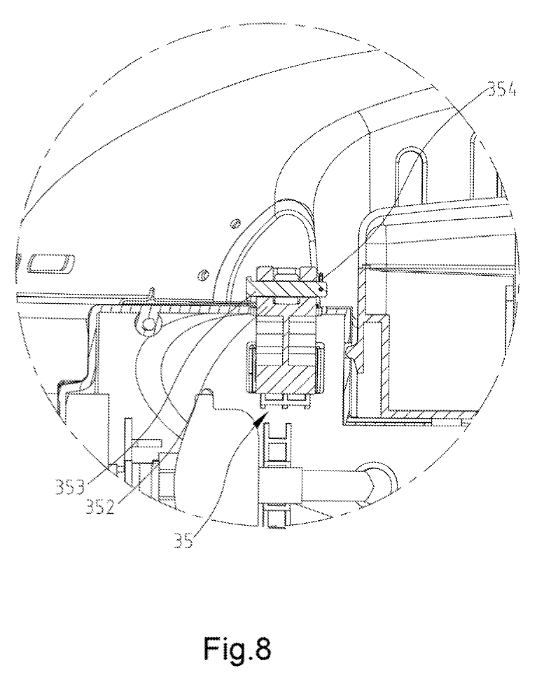

Referring to FIGS. 7 and 8, a pin 353 is driven into each of the ears 22 through the second portion 352 of a related one of the hinges 35 to pivotally connect the cover 20 to the hinges 35. A pin 354 is driven through each of the pins 353 to retain the pins 353 in the hinges 35. The second portions 352 of the hinges 35 are exposed from the cutouts 313 and 323.

The box 33 is formed with two hooks 331. The box 33 is disposed in the spaces 311 and 321. The hooks 331 are inserted in the slots 312 and 322 to retain the box 33 in the spaces 311 and 321. Things such as an illuminating device may be stored in the box 33.

A pipe 34 is disposed in the cylinder. The pipe 34 includes an end connected to the heater 12 and another end for connection to a fuel can. Thus, fuel such as gas can be provided to the heater 12 from the fuel can through the pipe 34.

A button 38 is provided on the cylinder and, more particularly, on the second shell 32 of the cylinder. An igniter wire 39 is disposed in the cylinder. The igniter wire 39 includes an end connected to the button 38 and another end located near the heater 12. The igniter wire 39 is actuated to ignite the fuel from the heater 12 by pushing the button 38.

The barbecue stove according to the present invention exhibits advantages. Firstly, it requires a small space in storage.

Secondly, the storage device can be used to store a fuel can and other things such as an illuminating device.

Thirdly, it is quiet during transportation since the grid does not rattle because of the brackets and the tabs.

Fourthly, the cover is not burning hot since it is far from the heater as first portions of the hinges are long.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A barbecue stove comprising a body, a cover pivotally connected to the body, a storage device attached to the body, two primary feet attached to the body and two secondary feet attached to the storage device so that the barbecue lies on the primary feet in use and stands on the secondary feet in storage.

2. The barbecue stove according to claim 1 comprising at least one hinge for pivotally connecting the cover to the body.

3. The barbecue stove according to claim 2 wherein the hinge comprises a first portion connected to the body and a second portion connected to the cover.

4. The barbecue stove according to claim 3 wherein the hinge is an L-shaped element.

5. The barbecue stove according to claim 4 wherein the first portion is much longer than the second portion.

6. The barbecue stove according to claim 3 comprising a threaded bolt for connecting the first portion of the hinge to the body.

7. The barbecue stove according to claim 6 comprising a tab provided between an enlarged head of the threaded bolt and the body.

8. The barbecue stove according to claim 1 wherein at least one of the body and cover comprises a handle formed thereon.

9. The barbecue stove according to claim 1 comprising a heater disposed in the body.

10. The barbecue stove according to claim 1 comprising a grid disposed in the body.

11. The barbecue stove according to claim 10 wherein the grid comprises two recesses for facilitating the handling thereof.

12. The barbecue stove according to claim 10 wherein the body comprises brackets formed thereon for supporting the grid.

13. The barbecue stove according to claim 1 wherein the storage device comprises a cylinder attached to the body and a box detachably attached to the cylinder.

14. The barbecue stove according to claim 13 wherein the cylinder comprises a space for receiving the box.

15. The barbecue stove according to claim 14 wherein the box comprises at least one hook formed thereon, and the cylinder comprises at least one slot for receiving the hook.

16. The barbecue stove according to claim 13 wherein the cylinder comprises at least one cutout for receiving the hinge.

17. The barbecue stove according to claim 13 wherein the cylinder includes a first shell attached to the body and a second shell attached to the first shell.

18. The barbecue stove according to claim 1 comprising two pads attached to the secondary feet.

19. The barbecue stove according to claim 9 comprising an igniter wire with a first end inserted in the body near the heater and a second end disposed in the cylinder.

20. The barbecue stove according to claim 19 comprising a button connected to an igniter wire and provided on the cylinder so that the button can be pushed to actuate the igniter wire.
